(19) United States
(12) Patent Application Publication
(10) Pub. No.: US 2007/0114849 A1
(43) Pub. Date: May 24, 2007

(54) Electrical load with preferential source

(75) Inventors: Ohad Falik, Kfar Saba (IL); Yachin Afek, Kfar Saba (IL); Lior Horwitz, Kfar (IL)

Correspondence Address: DAVIDSON, DAVIDSON & KAPPEL, LLC, 485 SEVENTH AVENUE, 14TH FLOOR, NEW YORK, NY, 10018, US

(73) Assignee: DSP Group Ltd., Herzlia (IL)

(21) Appl. No.: 11/282,980

(22) Filed: Nov. 18, 2005

(51) Int. Cl. H02J 9/00

(52) U.S. Cl. 307/64

(57) ABSTRACT

A regulator circuit, embedded in a device, which is adapted to draw power from a power source internal to the device and a power source external to the device. The regulator circuit includes a first circuit segment for regulating power supplied by the internal power source, a second circuit segment for regulating power supplied by the external power source, an output circuit segment that monitors the output of the regulator circuit and supplies regulated power to the device. Additionally, responsive to the monitoring the regulator circuit preferentially draws power from the second circuit segment and complements the drawn power with power from the first circuit segment to maintain a regulated power supply at the output.

### FIELD OF THE INVENTION

The present invention relates generally to internally powered devices with optional alternative power sources.

### BACKGROUND OF THE INVENTION

Battery powered devices are designed to accept power from alternative power sources. Such devices can include, for example, Personal Data Assistants (PDA), media players, digital cameras, mobile telecommunication devices, motors, and any other device or apparatus which is battery operated and can also receive power from an external power source. Such devices can be powered from a battery when other power sources are not available, for example, when the device is not connected to the external power source, or when the external power source is not available. Handheld devices are typically not connected to external power sources during travel or use. Other devices are sometimes connected to external power sources when used, for example wireless telephones employing a cradle for charging the battery. Some devices normally connected to external power sources will use power drawn from a battery when the external power source is not available, for example during a power outage and the like. Typically, the external power source is a DC power source powered from an AC electric socket to charge the device's battery and/or to power the device from the external power source. Powering devices from an external power source, or a power source other than the battery, conserve battery charge and improve longevity. Some devices include internal charging mechanisms, which allow charging the battery while powering the device from the external power source.

In many cases, when the device is powered from an external power source it disconnects the option of drawing power from the battery. Therefore, presently available devices will draw power from the external power source or from the battery, but not from both. In some cases an external power source has limitations on the amount of power it can supply. Thus, a device that requires more power than the external power source can supply, cannot be powered by the external power source, even if the device only occasionally has peak requirements which exceed the limits of the external power source. The Universal Serial Bus (USB) interface is an example of such an external power source. Some devices use the USB interface to connect peripherals and communicate with a computer but do not operate the device by drawing power from the USB port since their requirements exceed the port's capability. For example a USB 2.0 port is limited to providing 100 mA for a normal device and 500mA for a high power device. Typically such devices continue to use batteries even when connected to an external USB power source or require a connection to an additional external power source aside the USB connection.

Another example of a device that makes use of an external power source and a battery is an Uninterruptible Power Source (UPS) used as a back up power device for computing and other supported devices. When the main power source stops supplying power or fails to correctly supply a parameter of the required power, for example less than the required voltage or an unstable voltage or current frequency, the UPS will switch between the external power source and the battery and provide power to the supported device with battery power. In such a case the battery power source takes charge and provides the required power to the load instead of the external power source. When the main power source is functioning properly the battery is recharged by the main power source in parallel to the supply of power to power the load. A UPS directs the power to power the supported device either from the external power source (main) or the internal power source (battery) and does not complement the output power from the external power source with power from the internal source.

Likewise, in motorized vehicles during normal usage, power is generally supplied from a motor powered alternator or a rechargeable battery. Typically, excess charge from the alternator is used to recharge the battery and a deficiency of charge is complemented by the battery. Typically a control circuit is used to monitor the battery voltage and control the alternator output to prevent over charging the battery. However, it should be noted that the power source of the load automatically draws power from the available resources and is not controlled. Some batteries such as lead batteries can be charged freely, in contrast other batteries such as Li-Ion and Ni-Mh are limited in the number of charges and they require an accurate charging profile, for example taking into account the discharge level and controlling the current and voltage of the charge with dependence on time and temperature.

U.S. Pat. No. 4,104,539 to Hase describes a parallel redundant and load sharing regulated AC system. The system described has two power sources, a commercial (main) power source and an inverter. The two power sources share a load approximately equally. The inverter assumes the load if line quality is out of predetermined limits. On the other hand, if the inverter fails the commercial power line assumes the whole load. U.S. Pat. No. 6,236,582 to Jalaleddine describes a load share controller for balancing current between multiple supply modules. U.S. Pat. No. 4,359,679 to Regan describes a switching DC regulator and load sharing system for multiple regulators. U.S. Pat. No. 4,766,364 to Biamonte et al. discloses a parallel power system comprising a plurality of voltage regulating power supplies connected in a master slave configuration, the number of regulators being one greater than required to provide load current requirements. The master regulator generates a control signal to control the output of the individual slave regulators to provide balanced load sharing.

Typically, prior art devices use either the internal power source (e.g. battery) or the external power source. If the external source cannot supply the full power requirements it is not used. None of the prior art references disclose an apparatus and method for using external power sources first and complementing the supply of power to the powered device from the internal power source, when necessary. There is therefore a need in the art for a device with a regulator circuit that provides a regulated supply of power at its output for powering a load.

### SUMMARY OF THE INVENTION

An aspect of an embodiment of the invention relates to a device with a regulator circuit that provides a regulated supply of power at its output. The regulator circuit inputs power from at least two power sources. One of the sources is an internal power source (e.g. a battery), which is optionally able to provide sufficient power to generally power the device by itself. The second power source is external to the device. The regulator circuit monitors the power at the output to ensure a continuous supply satisfying the load. The regulator circuit provides preference in using the power supplied by the external power source, to conserve the power of the internal power source. The internal power source complements the power supplied by the external power source to enable provision of the required power at the output of the regulator circuit.

In an exemplary embodiment of the invention, the external power source provides sufficient power to power the regulated output therefore substantially no power is used from the internal power source when the external power source is available.

In an exemplary embodiment of the invention, the external power source does not provide any power therefore all of the power to power the regulated output is provided by the internal power source.

In an exemplary embodiment of the invention, the external power source is able to provide only some of the power required to power the regulated output and the rest is provided by the internal power source.

In an exemplary embodiment of the invention, the power output by the regulator circuit is not affected by the source of the power.

In some embodiments of the invention, the internal power source is a disposable battery. Alternatively, the internal power source is a rechargeable battery.

There is thus provided according to an exemplary embodiment of the invention, a regulator circuit, embedded in a device, which is adapted to draw power from a power source internal to the device and a power source external to the device, the regulator circuit comprising:
a first circuit segment for regulating power supplied by the internal power source;
a second circuit segment for regulating power supplied by the external power source;
an output circuit segment that monitors the output of the regulator circuit and supplies regulated power to the device; and
wherein responsive to the monitoring the regulator circuit preferentially draws power from the second circuit segment and complements the drawn power with power from the first circuit segment to maintain a regulated power supply at said output.

In an exemplary embodiment of the invention, the regulator circuit powers the device from the internal power source when an external power source is not connected. Optionally, the external power source is unable to provide sufficient power to power the device in some cases.

In an exemplary embodiment of the invention, the second circuit segment provides regulated voltage with a current limit. Optionally, the regulator circuit has a different reference voltage when providing power only from the external power source and when providing power in conjunction with power from the internal power source.

In an exemplary embodiment of the invention, the output circuit segment provides power of a substantially constant voltage regardless of the power source used to supply the power. Optionally, the output circuit segment provides power of different voltages dependent on the sources providing the power.

In an exemplary embodiment of the invention, fluctuations in the voltage provided by said output circuit segment are less than a predetermined percent of the magnitude of the provided voltage. Optionally, the power supplied by the external power source is direct current.

In an exemplary embodiment of the invention, the regulator circuit comprises multiple outputs drawing current from the same sources. Optionally, the multiple outputs provide different voltage levels.

In an exemplary embodiment of the invention, power from the internal source is used to complement the power from the external source only if the sums of the currents drawn by the multiple outputs exceed the current limit of the external source. Optionally, the internal power source is a disposable battery.

In an exemplary embodiment of the invention, the monitoring is performed by comparing the output voltage to a reference voltage. Optionally, the output provides direct current.

There is thus additionally provided according to an exemplary embodiment of the invention, a method of powering a device from an internal and external power source while conserving charge of the internal power source, comprising:

regulating the power supplied by the internal power source and the external power source;

monitoring the power supplied for powering the device;

attempting to draw all the power required by the device from the external power source;

compensating for unavailable power required by the device from the external power source by drawing power from the internal power source; and

combining the power from the external power source with the power from the internal power source to supply power to power the device.

In an exemplary embodiment of the invention, the external power source is unable to supply all the power required to power the device. Optionally, the external power source provides a constant voltage regardless of the external load.

In an exemplary embodiment of the invention, the output provides power of different voltages dependent on the power sources providing the power. Optionally, fluctuations in the voltage provided by said output are less than a predetermined percent of the magnitude of the provided voltage.

In an exemplary embodiment of the invention, the internal power source is a disposable battery. Alternatively, the internal power source is a rechargeable battery.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with a same or similar number in all the figures in which they appear, wherein:

FIG. 1 is a schematic illustration of a device with a regulator circuit, according to an exemplary embodiment of the invention;

FIG. 2 is a schematic diagram of a power regulating circuit, according to an exemplary embodiment of the invention;

FIG. 3 is a timing diagram, according to an exemplary embodiment of the invention;

FIG. 4 is a schematic diagram of an alternative power regulating circuit, according to an exemplary embodiment of the invention;

FIG. 5 is a timing diagram, based on an alternative regulating circuit according to an exemplary embodiment of the invention;

FIG. 6 is a schematic diagram of a power regulating circuit providing multiple outputs for multiple loads, according to an exemplary embodiment of the invention; and

FIG. 7 is a schematic diagram of a current regulator for a power regulating circuit with multiple outputs, according to an exemplary embodiment of the invention.

### DETAILED DESCRIPTION OF THE INVENTION

The present invention discloses a new and novel apparatus and method for conserving the power in an internal power source of a device when an external power source is available, by using whatever power is available from the external power source first and complementing the supply of power to the device from the internal power source, if and when necessary. The invention discloses a device with a regulator circuit that provides a regulated supply of power at its output for powering a load. The regulator circuit inputs power from at least two power sources. One of the sources is an internal power source, which is optionally able to provide sufficient power to power the device by itself. Such an internal power source can be a battery, optionally a rechargeable battery. The second power source is external to the device, such as for example, an AC power source coupled to an AC/DC converter, power provided by a USB output of a device or solar cells, which sometimes can contribute to powering the device . The regulator circuit monitors the power at the output to ensure a continuous supply satisfying the load. The regulator circuit gives preference in using the power supplied by the external power source, to conserve the power of the internal power source. The internal power source is used to complement the power supplied by the external power source to enable provision of the required power at the output of the regulator circuit.

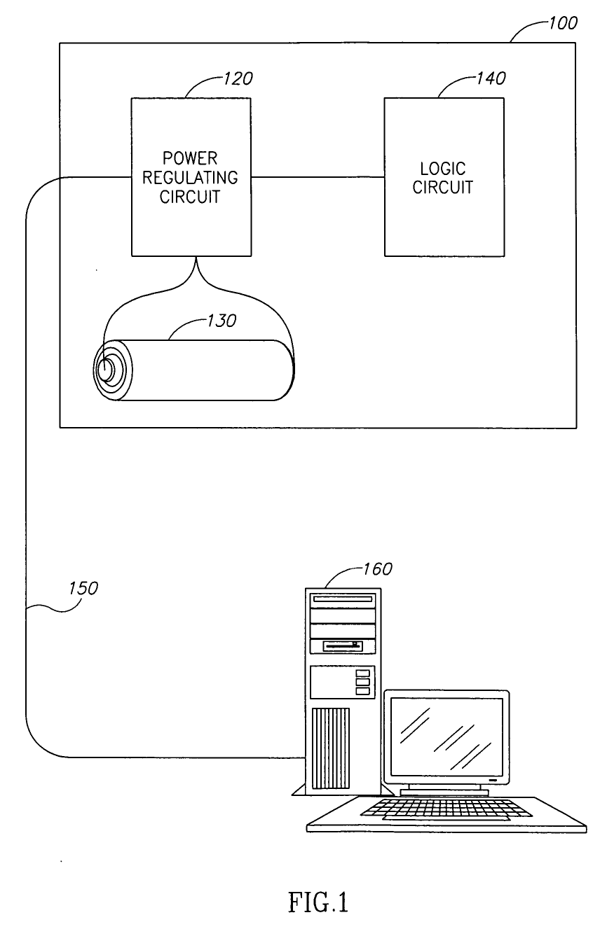

FIG. 1 is a schematic illustration of a device 100 with a power regulating circuit 120, according to an exemplary embodiment of the invention. In an exemplary embodiment of the invention, device 100 is a portable electronic device, for example an MP3 player, a cordless telephone base unit, a digital camera, a portable personal computer, or other devices. Optionally device 100 comprises a logic circuit 140, for providing device functionality. In an exemplary embodiment of the invention, device 100 comprises an internal power source 130 to provide electric current to power the device. In an exemplary embodiment of the invention, device 100 is adapted to accept power from an external power source in addition to internal power source 130. Optionally, power regulating circuit 120 accepts electrical power from internal power source 130 and the external power source simultaneously to provide regulated power to logic circuit 140. In an exemplary embodiment of the invention, power regulating circuit 140 provides preference to drawing power from the external power source over internal power source 130, wherein the internal power source complements for inability of the external power source to provide the power requirements of device 100. In some embodiments of the invention, the external power source provides AC current or DC current. Optionally, AC current is converted to DC current before being handled by power regulating circuit 120. In some embodiments of the invention, internal power source 130 is a disposable battery. Alternatively, internal power source 130 can be a rechargeable battery that is recharged external to device 100. In some embodiments of the invention, the internal power source is a mechanical or chemical source (e.g. based on fuel). In some embodiments of the invention, internal power source 130 is recharged by excess electric power when device 100 is attached to an external power source. Optionally, internal power source 130 provides a constant DC voltage. In an exemplary embodiment of the invention, device 100 is powered by internal power source 130 while a user is using device 100 as a portable device. Optionally, when the user is using device 100 in a supporting environment, for example at home or in an office, device 100 can be attached to an external power source, for example plugged into an electric socket (mains), to power the device and conserve battery charge. In some embodiments of the invention, device 100 requires a connection (constantly, periodically, frequently or non-frequently) to an external device (e.g. a computing device), for information exchange (e.g. transferring or backing up data), for functionality of the device, for example an Internet connection for an IP phone, or other reasons. Optionally, during the time that device 100 is connected to an external device, device 100 is optionally adapted to draw electric power from the external device through the connection, in order to conserve the charge of internal power source 130. In an exemplary embodiment of the invention, as shown in FIG. 1, device 100 is connected by a cable 150 to an external device, for example a computer 160. In some embodiments of the invention, device 100 is connected to the USB port of the computer or the serial or parallel port. Alternatively, device 100 may be connected to a 1394 port, PS2 port (e.g. the mouse port or the keyboard port or to other standard or non-standard ports of computer 160.) Typically, many computer ports supply a voltage line, for example +5V, to power attached devices. In some cases the amount of power (e.g., current) drawn from this port is limited, such as in the case of USB were a current limit depends on the state of operation and the type of device, for example 100 mA for a ‘standard’ devices or 500 mA for a high-power devices.

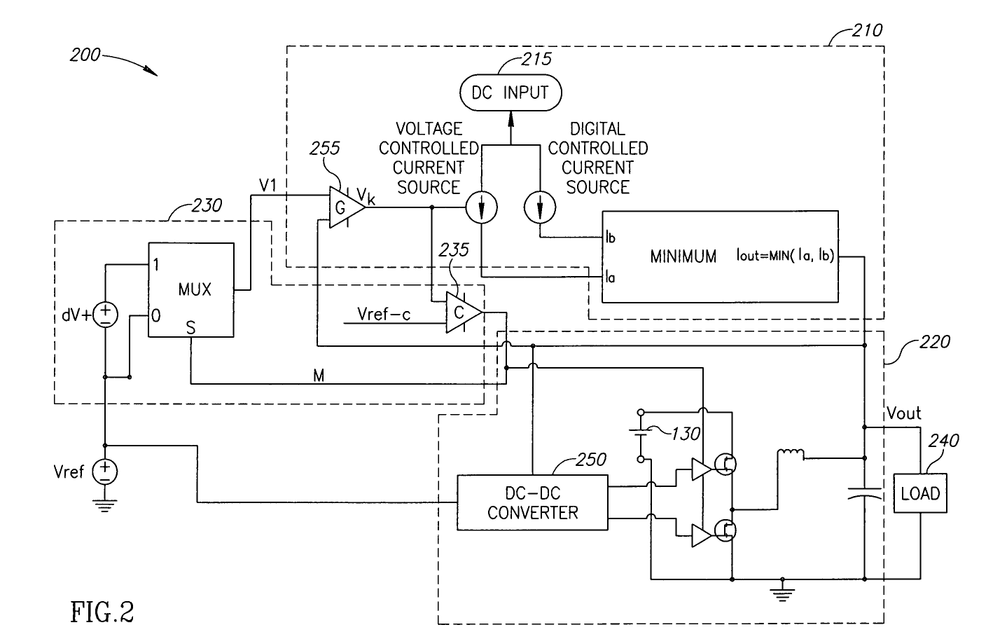

FIG. 2 is a schematic diagram of a power regulating circuit 200, according to an exemplary embodiment of the invention. As shown in FIG. 2 power regulating circuit 200 accepts power from two sources: an external power source 215 and internal power source 130. A circuit segment 210 accepts the power from external power source 215 and provides it to a load 240, for example logic circuit 140. Optionally, circuit segment 210 is a constant voltage current limiting circuit, for providing current to load 240. In an exemplary embodiment of the invention, a circuit segment 220 comprises internal power source 130 for providing power to load 240. In an exemplary embodiment of the invention, a circuit segment 230 comprises a comparator 235 that compares between a voltage related to the voltage supplied by the output of power regulator circuit 200 (e.g., Vout or a value proportional to Vout, such as via a resistor divider) and a reference voltage (Vref₁₃ c) of power regulating circuit 200, in order to control division of the supply of power by the two circuit segments (210, 220) of power regulating circuit 200. In an exemplary embodiment of the invention, Vref₁₃ c is defined so that comparator 235 will be activated when Vout drops below the desired voltage by a preset amount. Optionally, Vref₁₃c is defined to be Vref₁₃ c=Vk−G*(Vout₁₃min−Vref), where Vk is the voltage at the output of an amplifier 255, which amplifies voltage by the value G. Optionally, when Vout=Vref, Vout₁₃ min is the allowed drop of the output. Optionally, if amplifier 255 has a high value, the accuracy of Vref₁₃ c is not critical and may be set to a voltage within the dynamic range between Vk and Vref.

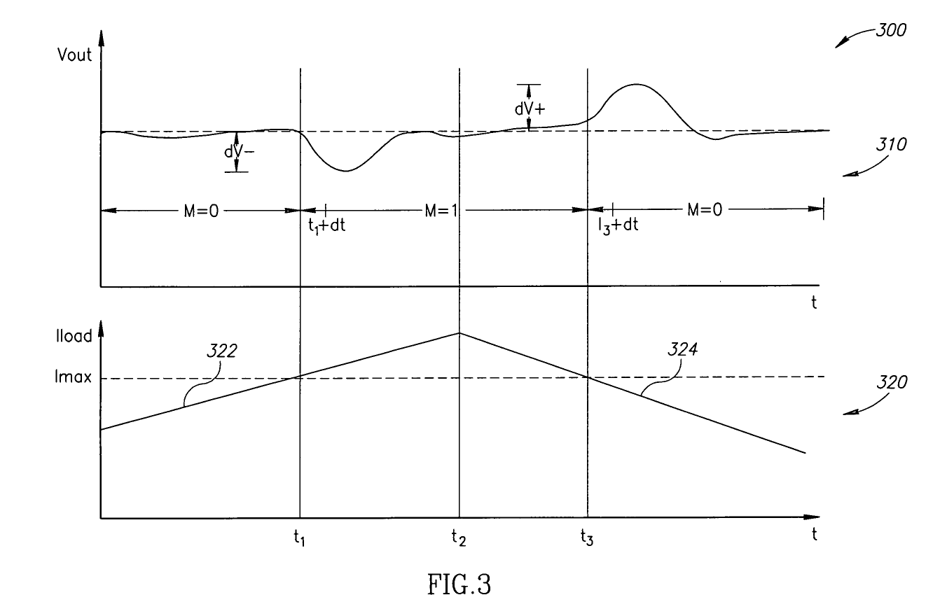

The function of power regulating circuit 200 will be clear from a discussion of its voltage output relative to the current provided to a load. FIG. 3 is a timing diagram 300 illustrating the function of power regulating circuit 200 of FIG. 2, according to an exemplary embodiment of the invention. Power regulating circuit 200 of FIG. 2 is initially in a first mode (M=0), designated by the output M of comparator 235. In an exemplary embodiment of the invention, load 240 draws an increasing current from power regulating circuit 200 as shown by line 322 of graph 320 in timing diagram 300. Initially, circuit segment 210 provides the full current demand of load 240 from the current provided by external power source 215. Graph 310 in timing diagram 300 shows the voltage as a function of time responsive to the current demands shown in graph 320. As the current demand of load 240 rises and draws near to the current limitation of circuit segment 210 (designated by Imax in FIG. 3), the voltage provided by circuit segment 210 begins to drop to allow the supply of the current demand. In an exemplary embodiment of the invention, comparator 235 receives on one input a voltage proportional to the difference between Vout and a voltage V1. Voltage V1 controls the output voltage of circuit segment 210. Optionally, voltage V1 depends on the output of comparator 235. Initially M=0 and V1 is equal to Vref. When M=1, V1 is equal to Vref+dv. It should be noted that the value of dv is selected based on the output voltage deviation allowed for Vout. Additionally, the value of dv is selected to be larger than normal voltage variations at the output due to small variations in the load, noise or other disturbances. In the shown embodiment, at time t1, when the current demand reaches and begins to exceed Imax, circuit segment 210 responds by lowering its output voltage (due to the current limit blocking a current increase from circuit segment 210). As a result, at time t1+dt, the output voltage provided by circuit segment 210 drops below Vout₁₃ min, comparator 235 is triggered, and the output M of comparator 235 is set to one (M=1) causing circuit segment 230 to change to a second mode. In an exemplary embodiment of the invention, when changing to the second mode (M=1) circuit segment 230 raises the value of V1 by dv, in order to assure that power regulator circuit 200 will remain in the second state (M=1) until the current demands of load 240 are reduced below Imax and the voltage provided by circuit segment 210 goes back to its initial value. In the second mode, circuit segment 220 is enabled to provide current from internal power source 130 to compensate the shortage in the current supplied from external power source 215. In the shown embodiment, the power supplied by circuit segment 220 raises the voltage on load 240 (Vout) substantially back to the initial voltage on load 240 before circuit segment 210 reduced its contribution due to the current limit. At this stage a DC-DC converter 250 in circuit segment 220 operates as a voltage regulator, were its control loop attempts to keep the voltage on load 240 stable substantially at the value of Vref. Initially, when changing to the second mode circuit segment 210 provides a current at the level of Imax by operating as a current source, since its reference voltage is raised to Vref+dv. In an exemplary embodiment of the invention, device 100 is designed to be able to be powered by internal power source 130 to allow portability or use without the need to be connected to an external power source. Therefore any power requirement by load 240 can be supplied by circuit segment 220 if not satisfied by the provision of circuit segment 210, unless internal power source 130 is depleted and needs to be recharged or replaced.

In an exemplary embodiment of the invention, DC-DC converter 250 of circuit segment 220 is in an enabled state before circuit segment 220 contributes current to load 240, for example in order to provide Vref or other control voltages. Optionally, when power regulator circuit 200 changes to the second mode, circuit segment 220 enables its output (e.g. enabling transistors controlling the output), and immediately provides current without a delay that is common in voltage regulator feedback loops (such a delay is typically used to prevent oscillations of the circuit on one hand, but limit the response to sharp changed at the output voltage on the other hand.

In an exemplary embodiment of the invention, at time t2, load 240 changes in a way that reduces current consumption as shown by line 324 in graph 320 of diagram 300. Optionally, the current supplied by circuit segment 220 which is compensating the current supplied by circuit segment 210 begins to decrease until circuit segment 210 is able to supply the current on its own (as noted before circuit 210 operates as a current source in this mode, thus provide a fixed amount of current to the load). In an exemplary embodiment of the invention, as the current drawn by load 240 is reduced to the level of Imax, the voltage on load 240 (Vout) begins to rise, since circuit segment 220 provides a substantially constant voltage contribution (e.g. Vref) and includes elements that prevent a reverse current flow from load 240 into elements of circuit segment 220 (e.g. a reverse current sense circuit that blocks the transistors gates). Optionally, at time t3 circuit segment 210 provides a constant current (Imax), that is above the consumption of load 240, causing an increase in the output voltage value (by up to dv above Vref), to which the reference voltage on comparator 235 is set for.

Optionally at time t3+dt Vout and V1 are very close in value (e.g., both are substantially at Vref+dv) triggering comparator 235 setting M back to zero (M=0) and returning circuit segment 230 to the first mode. Optionally, the switching point is determined by Vref, offset dv and an optional threshold value of the comparator for switching back to the first mode. Optionally, using a comparator with hysteresis the changing value is set close to V1=Vref+dv. When changing to the first mode circuit segment 220 is disabled and V1 returns back to its initial value (Vref). In an exemplary embodiment of the invention, circuit 200 provides a voltage output with a substantially constant value, for example approximately 5V, 3.3V, 3.0V, 1.8V or 1.5V or other values. Optionally, the value of dv used in various places in the circuit may vary from case to case in the circuit, however in all the circuit dv is generally of the same magnitude and is relatively small in comparison to Vref and Vout, for example less than a predetermined percent of these voltage values (e.g. 10%, 5%, 2% or 1%). In an exemplary embodiment of the invention, if no power is available from external power source 215, circuit segment 230 would change to mode M=1, since there is a difference between the output voltage of circuit segment 210 (0V) and the reference voltage. Optionally, being in mode M=1 enables circuit segment 220, so that internal power source 130 provides power for load 240. In an exemplary embodiment of the invention, external power source 215 provides the full power requirement of device 100 so that substantially no power is required from internal power source 130. In some embodiments of the invention, external power source 215 provides unstable power, for example a source that has fluctuations in the available current or a source that goes on and off.

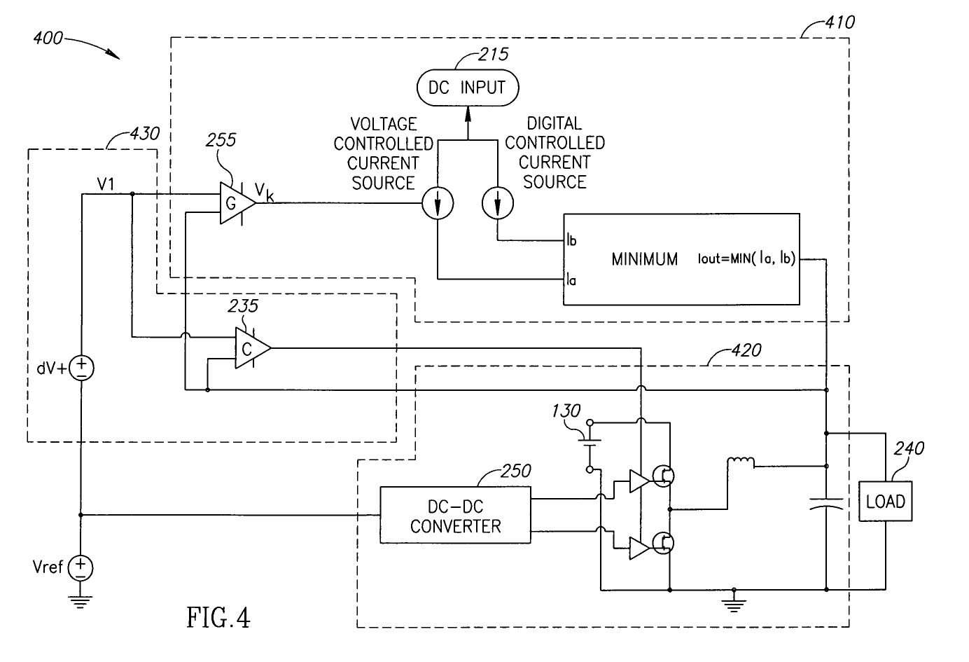

Optionally, many alternative circuits can be implemented, for example without changing the base voltage supplied to amplifier 255 between two modes. FIG. 4 is a schematic diagram of an alternative power regulating circuit 400, according to an exemplary embodiment of the invention. Similar to power regulating circuit 200, power regulating circuit 400 comprises a circuit segment 410, which provides power from an external source which is voltage regulated with a current limit; a circuit segment 420, which provides power from internal power source 130, and a circuit segment 430, which compares the voltage supplied by circuit segment 410 with a reference voltage provided by internal power source 130. In an exemplary embodiment of the invention, circuit segment 430 compares between voltages related to Vout and the reference voltage of power regulator circuit 400, in order to control division of power supply from the two circuit segments (410, 420). In power regulating circuit 400 the reference voltage V1 used to drive circuit segment 410 and indirectly also comparator 235, is set at a constant value, which is optionally a little higher (by a small value dv as described above) than the reference voltage of power regulating circuit 400. In contrast in power regulating circuit 200 the reference voltage used by comparator 235 alternates between Vref and Vref+dv. Optionally, comparator 235 in circuit 400 can be connected to the output of amplifier 255 as in circuit 200 instead of the input to amplifier 255. Optionally, in such a case the reference voltage of the comparator would be set as described above for circuit 200 (Vref₁₃ c).

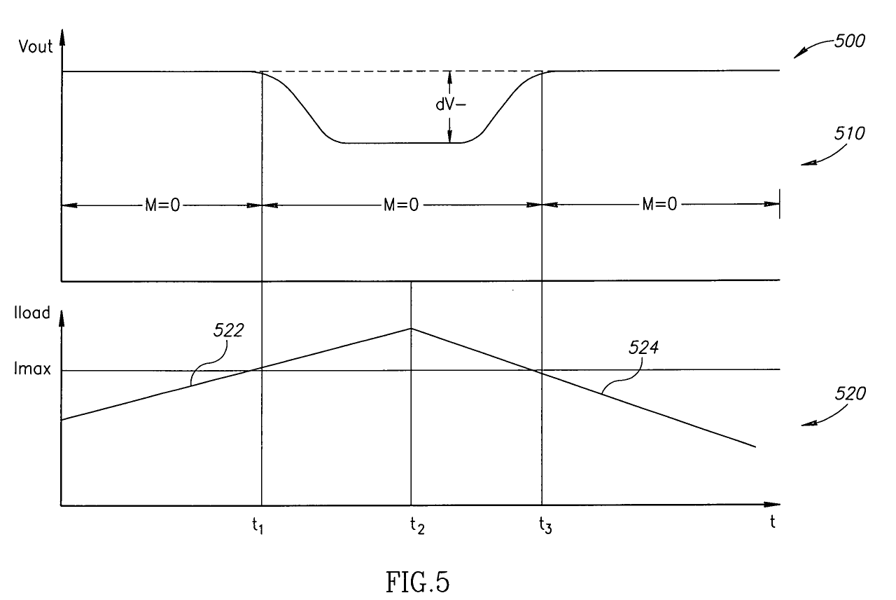

FIG. 5 is a timing diagram 500, according to an exemplary embodiment of the invention. In an exemplary embodiment of the invention, power regulating circuit 400 is initially in a first mode, designated as M=0. In an exemplary embodiment of the invention, load 240 draws current from circuit 400 at an increasing amount as shown by line 522 of graph 520 in timing diagram 500. Initially, circuit segment 410 provides the full current demand of load 240 from the current provided by external power source 215. Graph 510 in timing diagram 500 shows the voltage as a function of time responsive to the current demands shown in graph 520. As current demands of load 240 rise and draw near to the current limit of circuit segment 410 (designated by Imax in FIG. 5), the voltage provided by circuit segment 410 begins to drop as the current limit circuit takes control. In an exemplary embodiment of the invention, at time t1 in graph 510, the output voltage provided by circuit segment 410 drops by a preset value (dv), which is defined by the comparator threshold. Comparator 235 is triggered by the voltage drop (dv), causing the output M of comparator 235 to be set to one (M=1) and circuit segment 400 changes to a second mode. In an exemplary embodiment of the invention, in the second mode circuit segment 420 is enabled to provide current from internal power source 130 to compensate the shortage in current supplied from external power source 215. Optionally, voltage of the power supplied by circuit segment 420 is driven at the reference voltage level of power regulating circuit 400, thus keeping the voltage output at the level of the reference voltage of power regulating circuit 400. In an exemplary embodiment of the invention, at time t2, load 240 begins to reduce current consumption as shown by line 524 in graph 520 of diagram 500. The current supplied by circuit segment 420 which is compensating the current supplied by circuit segment 410 begins to decrease until circuit segment 410 is able to provide the required current on its own. At this point the current supplied by circuit segment 420 is zero. In an exemplary embodiment of the invention, as the current drawn by load 240 is reduced further, the voltage on load 240 (Vout) begins to rise, since circuit segment 420 does not sink any current (e.g. by utilizing reverse current detectors as discussed above which disconnect its output transistors), and circuit segment 210 provides a constant current Imax. As a result the voltage supplied by circuit segment 210 rises by up to the value of dv. Once the output voltage reaches Vout=V1=Vref+dv as the current drawn from it is reduced below Imax, circuit segment 210 returns to voltage regulation mode of operation, wherein the voltage is stabilized at Vout=V1. At that time (noted as t3) the voltage from circuit segment 410 is back at its initial value (reference voltage of power regulating circuit 400 (Vref)+dv). The reduction of the difference in voltage between Vout and the reference value of comparator 235 as defined by the hysteresis of the comparator (which prevents it from vibrating), un-triggers comparator 235 setting M back to zero (M=0). When M is set back to zero, circuit segment 430 returns to the first mode and the output drive of circuit segment 420 is disabled. Note that in the exemplary embodiment, as discussed above, in state M=0, the DC-DC circuit 420 is enabled but the output transistors are disabled. In this state the output is disabled but the control loop of the regulating circuit is active and is at a “working point” of its control loop. This guarantee fast response of the circuit to a change from state M=0 to M=1, without delays associated with its feedback loops. Optionally the comparator 235 may be connected to the output of amplifier G in 410, similar to the connection shown in FIG. 2, with proper adjustment to its thresholds. In an exemplary embodiment of the invention, if no power is available from external power source 215, circuit segment 430 would change to mode M=1, since there is a big difference between the output voltage of circuit segment 410 (0V) and the comparators reference voltage. Optionally, being in mode M=1 enables circuit segment 420, so that internal power source 130 provides power for load 240.

In an exemplary embodiment of the invention, power regulating circuit 200 provides a more uniform voltage output than power regulating circuit 400. Optionally, a device with less tolerance to variation in voltage would prefer power regulating circuit 200 over power regulating circuit 400. In some embodiments of the invention, circuit 400 is more simplistic than power regulating circuit 200. In some embodiments of the invention, the voltage difference provided by power regulating circuit 400 is selected to be significant in order to provide a different voltage when powering device 100 from an internal power source and an external power source. In some embodiments of the invention, other circuit layouts are used to control usage of power from available power sources. In some embodiments of the invention, circuit 210 (shown as a linear regulator) is a DC-DC converter circuit. In other embodiments, DC-DC converter 250 is a linear regulator.

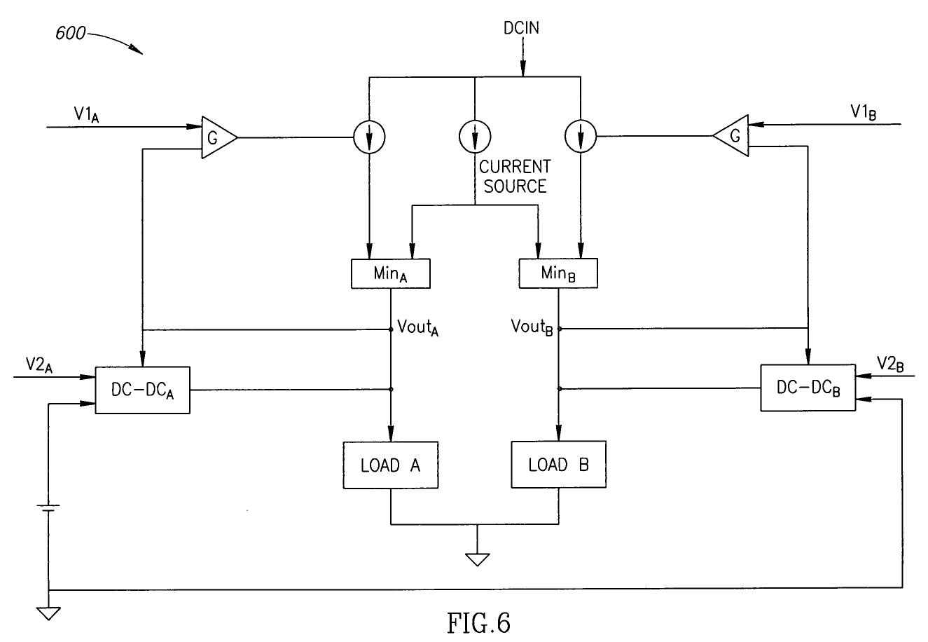

In some embodiments of the invention, it is desirable to power two or more different loads from the same internal power source and same external power source. FIG. 6 is a schematic diagram of a power regulating circuit 600 providing multiple outputs for multiple loads, according to an exemplary embodiment of the invention. In an exemplary embodiment of the invention, power regulating circuit 600 may be implemented for example as shown in FIG. 6, to provide more than one output port (e.g. Vout₁₃ a, Vout₁₃ b) allowing different voltage levels on each port. Optionally, circuit 600 is based on circuits 200 and 400 and created by duplicating the comparator circuit segment sharing a common enhanced internal source and external source. In an exemplary embodiment of the invention, each port allows a load to draw power from circuit 600, wherein the total power provided by circuit 600 from the “DC IN” is divided between the loads without pre-allocating the available power between the loads. As described above regarding circuits 200 and 400, circuit 600 preferentially draws power from the external power source (DC IN) and compensates the power output with power from the internal power source, when the total power drawn by both loads exceeds the maximal power that the external power source can provide (IoutA+IoutB>Imax).

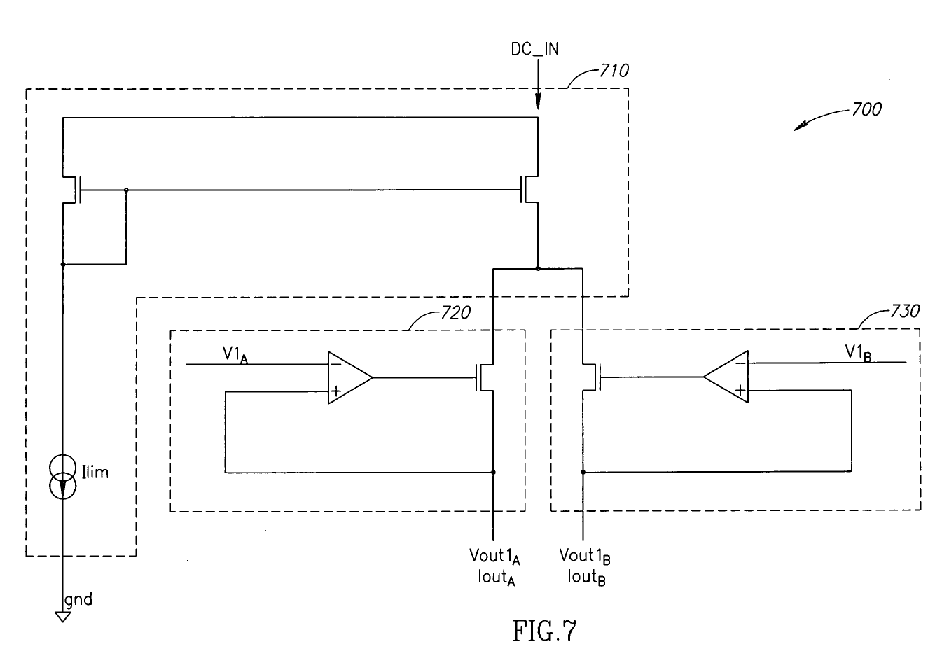

FIG. 7 is a schematic diagram of a circuit segment 700, representing an implementation of a current regulator for a power regulating circuit with multiple outputs as shown in FIG. 6, according to an exemplary embodiment of the invention. Optionally, circuit segment 700 provides current to two outputs with different voltages (VoutA and VoutB) as shown in the FIG. 7. In an exemplary embodiment of the invention, a circuit segment 710 serves as a current source common to both outputs, and circuit segments 720 and 730 serve as voltage regulators for the outputs. The serial connection of circuit segment 710 to circuit segments 720 and 730 implements a minimum function such that VoutA and VoutB are essentially the minimum between the current limit and the voltage limit.

It should be noted that FIG. 6 and FIG. 7 give the general layout for a regulator circuit providing for multiple loads that draw power from an internal and external source, a complete implementation of such a circuit is easily provided by one skilled in the art.

In an exemplary embodiment of the invention, one skilled in the art would be able to apply the above described methods and apparatus to other circuits and power sources dealing with alternating currents. The reference to regulator circuits in the above description refers to all types of, circuits that control a DC output based on an input. These circuits include among others DC-DC regulators and linear regulators.

It should further be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention. Section headings are provided for assistance in navigation and should not be considered as necessarily limiting the contents of the section. It will be appreciated by persons skilled in the art that the present invention is not limited to what has been particularly shown and described hereinabove. Rather the scope of the present invention is defined only by the claims, which follow.

1. A regulator circuit, embedded in a device, which is adapted to draw power from a power source internal to the device and a power source external to the device, said regulator circuit comprising:
a first circuit segment for regulating power supplied by the internal power source;
a second circuit segment for regulating power supplied by the external power source;
an output circuit segment that monitors the output of the regulator circuit and supplies regulated power to said device; and
wherein responsive to said monitoring said regulator circuit preferentially draws power from said second circuit segment and complements the drawn power with power from said first circuit segment to maintain a regulated power supply at said output.

2. A regulator circuit according to claim 1, wherein said regulator circuit powers said device from said internal power source when an external power source is not connected.

3. A regulator circuit according to claim 1, wherein said external power source is unable to provide sufficient power to power said device in some cases.

4. A regulator circuit according to claim 1, wherein said second circuit segment provides regulated voltage with a current limit.

5. A regulator circuit according to claim 4, wherein said regulator circuit has a different reference voltage when providing power only from said external power source and when providing power in conjunction with power from said internal power source.

6. A regulator circuit according to claim 1, wherein said output circuit segment provides power of a substantially constant voltage regardless of the power source used to supply the power.

7. A regulator circuit according to claim 1, wherein said output circuit segment provides power of different voltages dependent on the sources providing the power.

8. A regulator circuit according to claim 1, wherein fluctuations in the voltage provided by said output circuit segment are less than a predetermined percent of the magnitude of the provided voltage.

9. A regulator circuit according to claim 1, wherein said power supplied by the external power source is direct current.

10. A regulator circuit according to claim 1, comprising multiple outputs drawing current from the same sources.

11. A regulator circuit according to claim 10, wherein said multiple outputs provide different voltage levels.

12. A regulator circuit according to claim 10, wherein power from said internal source is used to complement the power from said external source only if the sums of the currents drawn by the multiple outputs exceed the current limit of said external source.

13. A regulator circuit according to claim 1, wherein said internal power source is a disposable battery.

14. A regulator circuit according to claim 1, wherein said monitoring is performed by comparing said output voltage to a reference voltage.

15. A regulator circuit according to claim 1, wherein said output provides direct current.

16. A method of powering a device from an internal and external power source while conserving charge of the internal power source, comprising: regulating the power supplied by the internal power source and the external power
source;
monitoring the power supplied for powering the device; attempting to draw all the power required by the device from the external power
source;
compensating for unavailable power required by the device from the external power source by drawing power from the internal power source; and
combining the power from the external power source with the power from the internal power source to supply power to power the device.

17. A method according to claim 16, wherein said external power source is unable to supply all the power required to power the device.

18. A method according to claim 16, wherein said external power source provides a constant voltage regardless of the external load.

19. A method according to claim 16, wherein said output provides power of different voltages dependent on the power sources providing the power.

20. A method according to claim 16, wherein fluctuations in the voltage provided by said output are less than a predetermined percent of the magnitude of the provided voltage.

21. A method according to claim 16, wherein said internal power source is a disposable battery.

22. A method according to claim 16, wherein said internal power source is a rechargeable battery.
